(19) United States
(12) Patent Application Publication
(10) Pub. No.: US 2010/0257054 A1
(43) Pub. Date: Oct. 7, 2010

(54) METHOD AND SYSTEM FOR EFFICIENT AND EXPRESSIVE ADVERTISING AUCTIONS

(75) Inventors: David J. Martin, Ithaca, NY (US); Joseph Y. Halpern, Ithaca, NY (US); Johannes Gehrke, Ithaca, NY (US)

Correspondence Address: BURNS & LEVINSON, LLP, 125 SUMMER STREET, BOSTON, MA, 02110, US

(73) Assignee: CORNELL UNIVERSITY, Ithaca, NY (US)

(21) Appl. No.: 12/675,418

(22) PCT Filed: Aug. 27, 2008
(86) PCT No.: PCT/US2008/074475

§ 371 Date: Apr. 26, 2010

Related U.S. Application Data
(60) Provisional application No. 60/968,156, filed on Aug. 27, 2007.

(51) Int. Cl. G06Q 30/00; G06Q 10/00; G06Q 50/00

(52) U.S. Cl. 705/14.46; 705/14.71

(57) ABSTRACT

A system and method for allowing advertisers to express bids as bidding programs that take as input, for example, a search query and various statistics about auction history and performance, for outputting bids on output characteristics such as, for example, clicks, purchases, and slot positions, and for providing an efficient, scalable, and parallelizable algorithm to solve winner determination given the bids output by the bidding programs.

### BACKGROUND

The system and method of the present embodiment relate generally to expressive bidding for advertising slot auction bidding, thus allowing advertisers to achieve advertising goals, while still providing fast and scalable techniques for winner determination, i.e. determining, for each auction slot available, the bidder to which the auction slot should be assigned.

With the vibrant activity of the Internet, Internet pages have become a thriving advertising platform. The results of, for example, a search query are presented to the user as a web page that contains a limited number of slots for advertisements (typically between four and twenty). These slots are sold to advertisers via an auction mechanism that charges an advertiser only if a user clicks on the advertiser's ad. This auction mechanism is referred to as a sponsored auction or advertising auction, and, in particular, a sponsored search auction, when a search provider such as GOOGLE® provides the auction. Sponsored search auctions proceed according to the following steps: (1) advertisers submit bids on user clicks for certain keywords offline, (2) a user submits a search query, (3) slots are assigned to advertisers by the search provider based on the advertisers' bids, (4) the search result page is returned to the user who may now click on one or more of the sponsored links, and (5) the search provider charges an advertiser according to some pricing rule if the user clicks on the advertiser's sponsored link. In the above process, advertisers are limited to submitting a single bid on whether or not the user clicks on the advertiser's ad. Further, although advertisers making use of the above process can specify a limited number of parameters to constrain their bids (such as a daily budget, and geographic targets), they cannot express the majority of their preferences and how they change over time because of limitations in the bidding language and response time constraints. For example, advertisers could be interested in maintaining a specified slot position during certain hours of the day, and/or maintaining a slot position above a specified competitor, and/or equalizing the return on investment (ROI) across multiple keywords.

What is needed are a system and method that allow an advertiser to bid on multiple features, for example, whether the user who submitted the query not only clicks on the advertiser's ad but also makes a purchase based on the advertiser's ad, or, for example, whether the advertiser's ad is displayed, and where on the Internet page the ad is displayed. Further, what is needed are a system and method in which the auction winners in a multi-feature auction are determined quickly enough so as not to impact response time and the user's experience with the Internet page that includes the ads. Still further, what is needed is a more expressive language that allows advertisers to express bidding preferences. Even still further, what is needed is a method to update the preferences of advertisers taking into account the bidding performance of the advertisers.

### SUMMARY

The needs set forth above as well as further and other needs and advantages are addressed by the embodiments set forth below.

The present embodiment can allow advertisers to express bids as bidding programs that take as input, for example, a search query and various statistics about auction history and performance. The present embodiment can further output bids on output characteristics such as, for example, clicks, purchases, and slot positions. Also, the present embodiment can provide an efficient, scalable, and parallelizable algorithm to solve winner determination given the bids output by the bidding programs, and can reduce the amount of work necessary for evaluating the bidding programs of multiple advertisers. The method of the present embodiment for providing an auction for advertising slots can include, but is not limited to including, the step of providing a computer-readable auction program template to a bidder, where the computer-readable auction program template can include output characteristics 47 with conditions. The method can also include the steps of receiving an instantiated computer-readable auction program template including bids for the output characteristics, and forming a computer-readable auction program from the instantiated computer-readable auction program template, where the computer-readable auction program can include an advertising slot bid for the advertising slot, where the advertising slot bid is computed from the bids for at least one of the output characteristics for the advertising slot associated with when the conditions hold. The method can further include the steps of receiving computer-readable user input, determining, from the computer-readable auction programs and the computer-readable user input a winner of the auction for each of the advertising slots. The step of determining a winner can include, but is not limited to including, the steps of choosing a subset of up to k² bidders, k bidders for each of the k advertising slots, from the bidders, where k is the number of the advertising slots, and choosing, from the subset, a winner for each of the k advertising slots based on the advertising slot bid and based on the computer-readable user input. The method for providing an auction for advertising slots can still further include the step of displaying an advertisement in each of the advertising slots, the advertisement being associated with the winner of the advertising slot. The computer-readable auction program template 41 can include, but is not limited to including, an accommodation such that each of the at least one bidders can bid on a plurality of the outcome characteristics simultaneously. The function to compute the advertising slot bid is the sum of the bids, if any, associated with the plurality outcome characteristics 47 for which the conditions hold.

The system of the present embodiment for providing an auction for advertising slots can include, but is not limited to including, a program creator/updater for receiving from each bidder, computer-readable instantiations of the computer-readable auction program template and producing from the computer-readable instantiations least one computer-readable auction programs associated with each bidder. The computer-readable auction program can maintain an internal state and can include bids on output characteristics with conditions. Program creator/updater 23 can interpret the bids for the output characteristics such that if more than one of the conditions holds, an advertising slot bid is computed as a function of the values of the output characteristics for the conditions that hold. The system can also include a user interface for receiving computer-readable user input, and a winner determination processor for determining, from the bidders and for each of the advertising slots, a winner of the auction by. The winner determination processor can determine a winner by receiving the computer-readable auction programs from the bidders through the program creator/updater, receiving computer-readable user input from the user through the user interface, choosing a subset of up to k² bidders, k bidders for each of the k advertising slots, from the pool of bidders, where k is the number of the advertising slots 51, and choosing, from the subset, a winner for each of the advertising slots based on the advertising slot bids in the computer-readable auction programs for each bidder of the subset and based on said computer-readable user input. The user interface displays an advertisement in each of the advertising slots. The advertisement is associated with the winner of the advertising slot.

For a better understanding of the present embodiments, together with other and further objects thereof, reference is made to the accompanying drawings and detailed description.

DESCRIPTION OF THE SEVERAL VIEWS OF THE DRAWING

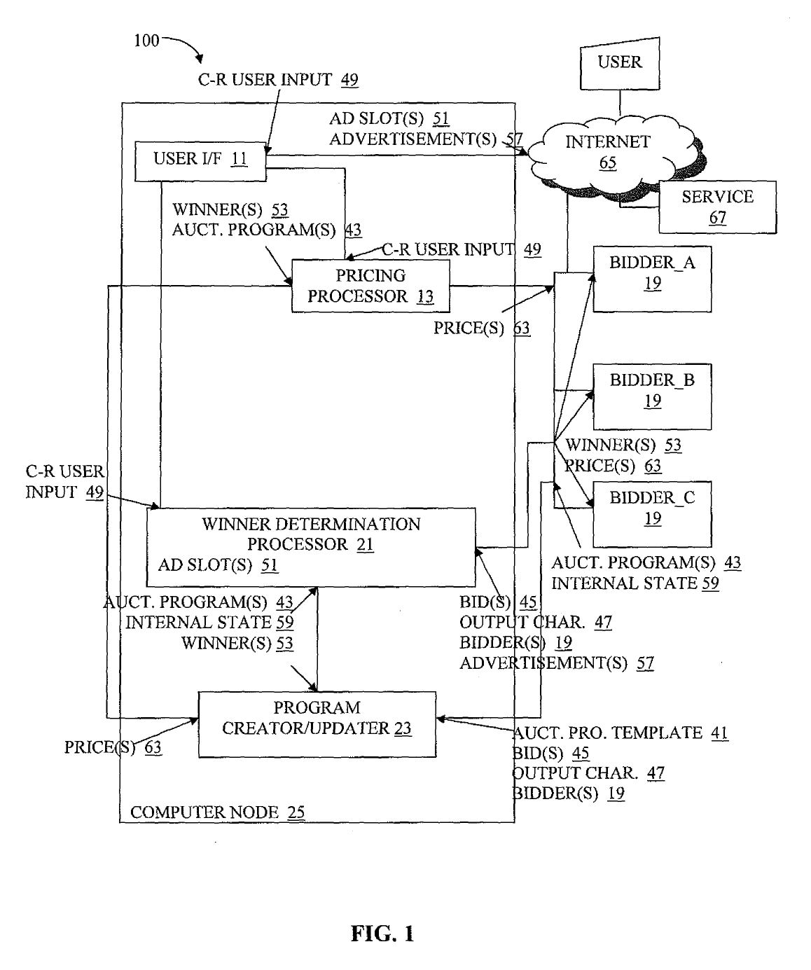

FIG. 1 is a schematic block diagram of the system of the present embodiment;

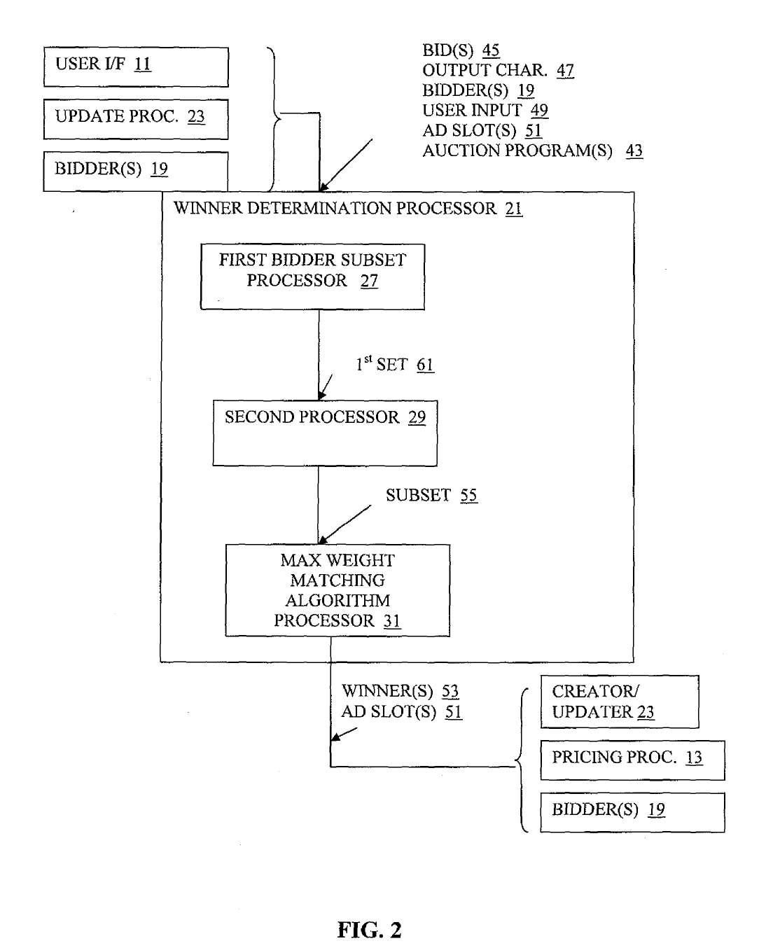

FIG. 2 is a schematic block diagram of the winner determination process;

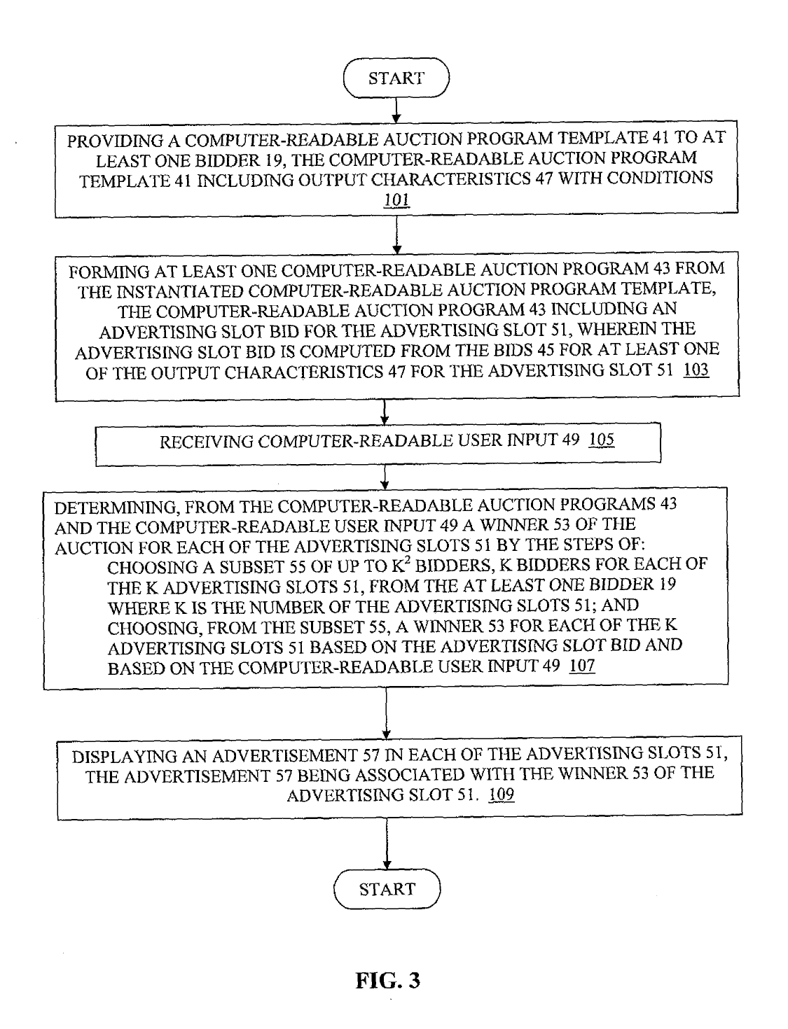

FIG. 3 is a flowchart of the method of the present embodiment;

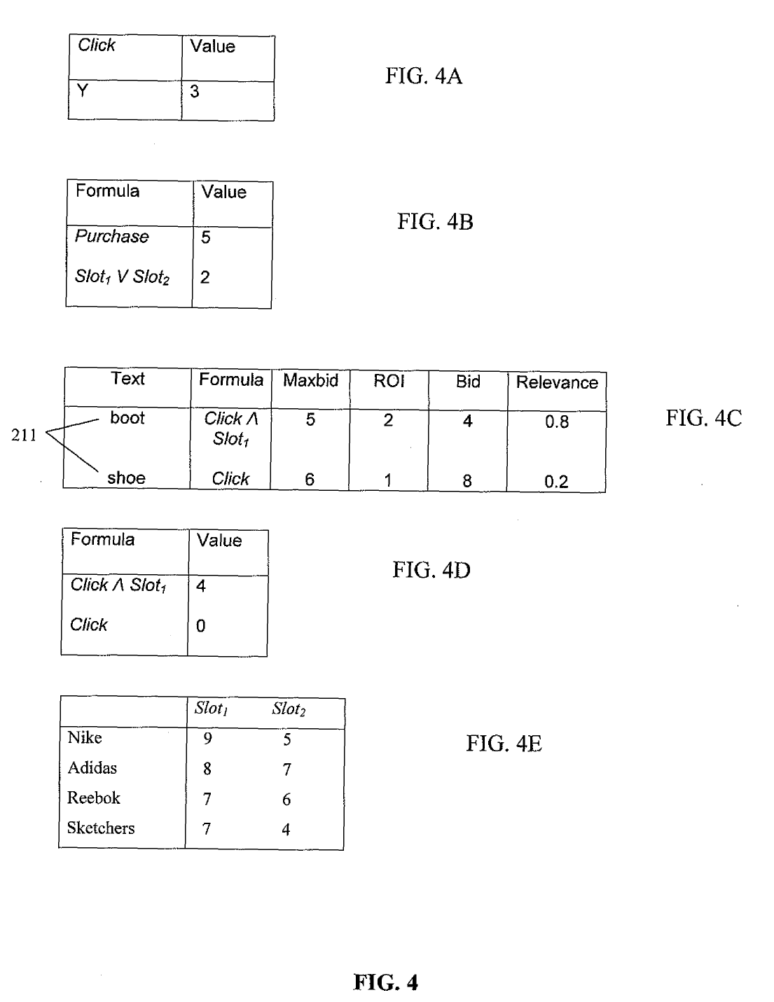

FIGS. 4A-4D are exemplary bids tables of the present embodiment;

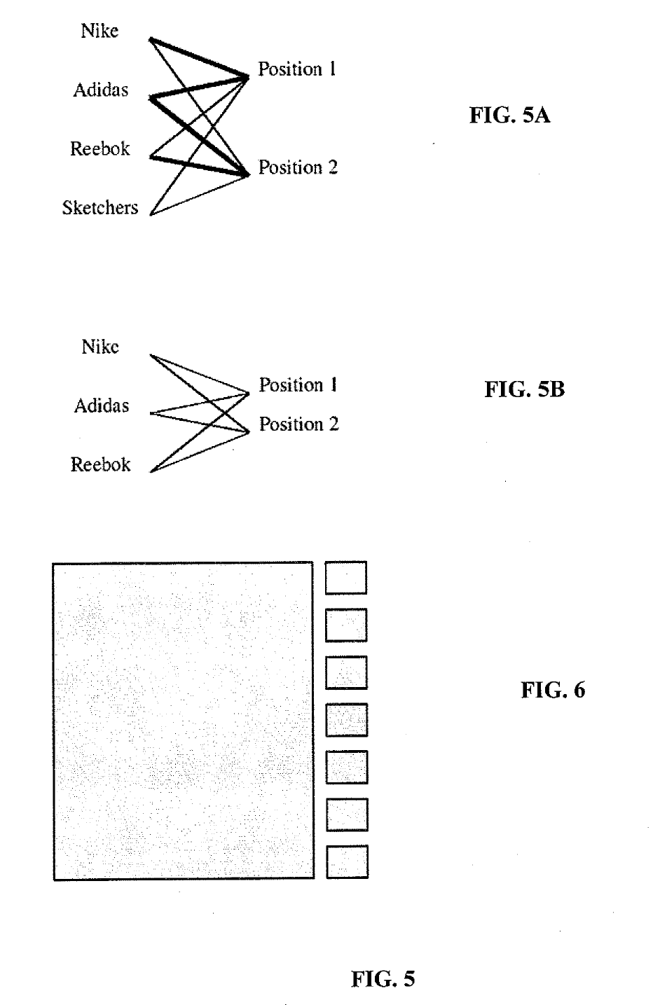

FIG. 5A is an exemplary bipartite graph;

FIG. 5B is an exemplary reduced bipartite graph based on the bipartite graph of FIG. 5A;

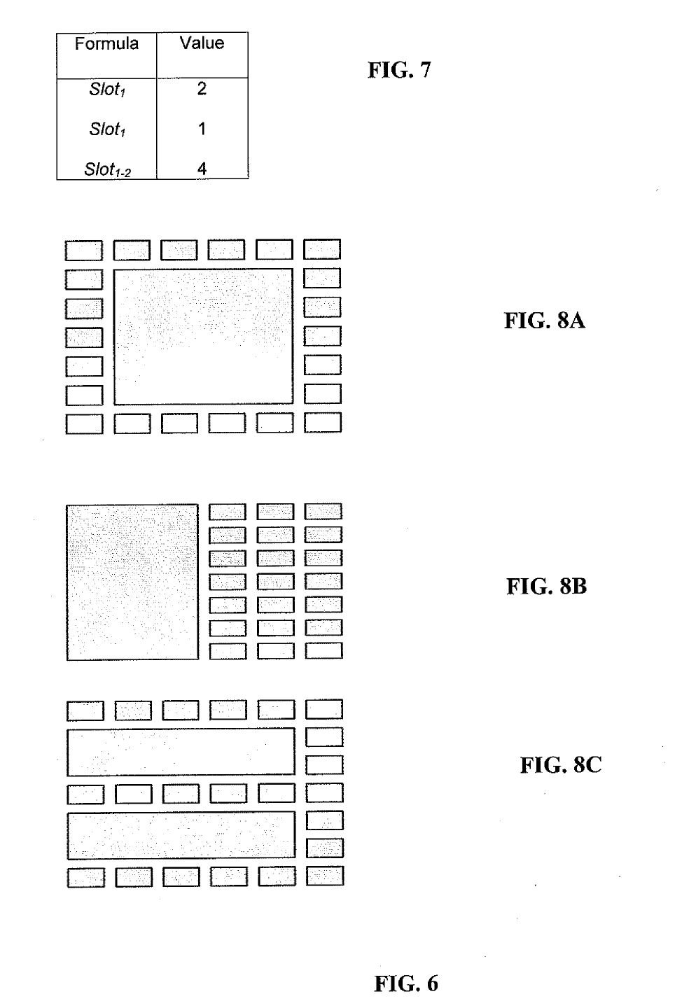

FIG. 6 is an exemplary one-dimensional array of advertisement slots in list layout;

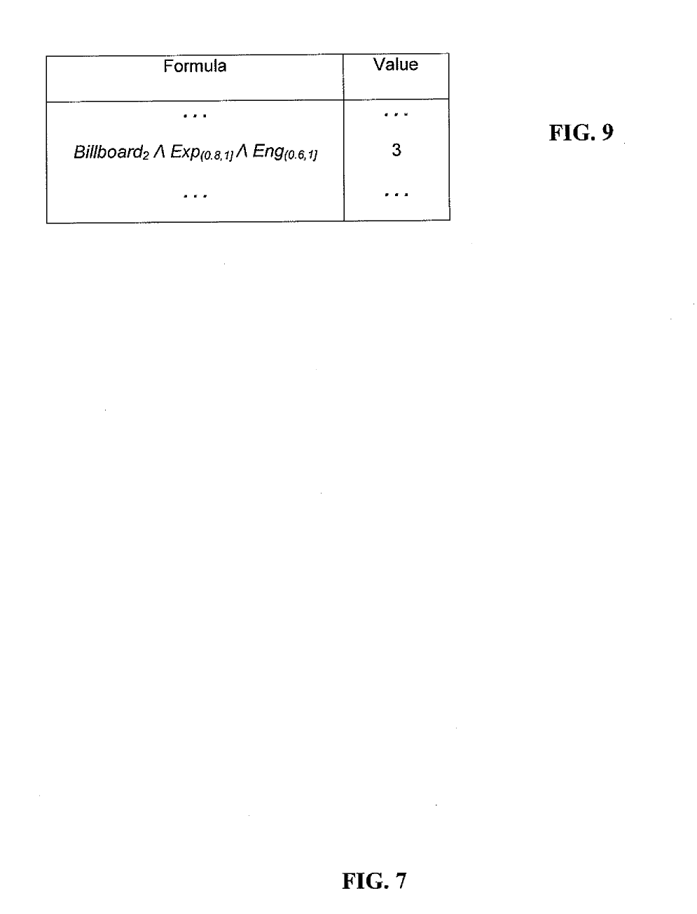

FIG. 7 is an exemplary OR-bid table;

FIG. 8A is an exemplary array of advertisement slots in a ring layout;

FIG. 8B is an exemplary array of advertisement slots in a grid layout;

FIG. 8C is an exemplary array of advertisement slots in a tree layout; and

FIG. 9 is an exemplary bids table associated with an in-game billboard.

### DETAILED DESCRIPTION

The present embodiments are now described more fully hereinafter with reference to the accompanying drawings. The following configuration description is presented for illustrative purposes only. Any computer configuration and architecture satisfying the speed and interface requirements herein described may be suitable for implementing the system and method of the present embodiments.

The system and method of the present embodiment include a programming language that allows advertisers to express complex preferences that may change over time. Advertisers can submit their bidding strategies as computer-readable auction programs for an Internet application, such as, for example, a search provider, a mapping system, or a multi-player game, to run. Conceptually, each time a user submits, for example, a search query to the search provider, these computer-readable auction programs are triggered. The main purpose of these computer-readable auction programs is to output bids on outcome characteristics, for example, clicks, purchases, and slot positions that may result from displaying the advertiser's ad on the result page. The programs can begin as templates that can allow bidders to submit dynamic bidding programs as instantiations of the templates. Bidders can bid on multiple features of auction outcomes, such as (but not restricted to) clicks, purchases, and slot positions. Users can fill in the bids tables, where each row can describe what the user is willing to bid for certain conditions. If multiple conditions hold, then the bidder is assumed to be willing to pay for all of them. For example, if the bidder bids $2 for being in either advertising slot 2 or 3, and $5 for a click, and then if the bidder is placed in position 3 and gets a click, the final bid is $7. Those skilled in the art will appreciate that such a language can allow bidders to express a wide range of preferences succinctly.

Each computer-readable auction program can be used to create a bids table each time there is an advertising auction. The computer-readable auction programs can access variables that are pertinent to the auction and to the advertiser, such as the keywords in a search query, time of day, the advertiser's remaining budget, the current return on investment for the keywords that the advertiser is interested in, the bidder's auction history, and so on. These variables can be stored in tables, some of which can be read-only shared between all advertisers (such as the time and location of the search) and some of which can be private to each advertiser (such as information about the keywords in which the advertiser is interested). The computer-readable auction programs can then be written in, for example, SQL. SQL triggers can be used to activate the computer-readable auction programs when an auction begins and to notify the computer-readable auction programs if they received a slot, click, or purchase. The computer-readable auction programs can modify tables that are private to the advertiser, and variables that are common to all computer-readable auction programs, such as amount spent, budget remaining, return on investment for various keywords, etc. can be automatically maintained for each computer-readable auction program by the Internet application.

Referring now primarily to FIG. 1, system 100 of the present embodiment for providing an auction for advertising slots 51 can include, but is not limited to including, a program creator/updater 23 for receiving from each bidder 19, computer-readable instantiations of computer-readable auction program template 41 and producing from computer-readable instantiations at least one computer-readable auction program 43 associated with each bidder 19. The computer-readable auction program 43 can maintain an internal state 59 and can include a bid 45 for output characteristics 47 and conditions specified by bidder 19. Program creator/updater 23 can interpret bids 45 for output characteristics 47 such that if more than one of the conditions holds, an advertising slot bid is computed as a function of the values for said output characteristics 47 for which the conditions hold. System 100 can also include user interface 11 for receiving computer-readable user input 49 and winner determination processor 21 for determining, from bidder 19 and for each advertising slot 51, winner 53 of the auction by.

Continuing to refer to FIG. 1, winner determination processor 21 can include, but is not limited to including, the steps of receiving computer-readable auction program 43 from bidder 19 through program creator/updater 23, receiving computer-readable user input 49 from a user through user interface 11, choosing subset 55 of up to k² bidders, k bidders for each of the k advertising slots 51, from bidder 19, where k is the number of the advertising slots 51, and choosing, from subset 55, winner 53 for each advertising slot 51 based on the advertising slot bid in one computer-readable auction program 43 for each bidder 19 of said subset 55, and based on computer-readable user input 49. User interface 11 can display advertisement 57 in each of advertising slots 51. Advertisement 57 is associated with winner 53 of advertising slot 51. Computer-readable auction program template 41 can include a plurality of outcome characteristics 47 and conditions such that each of bidder 19 can bid on a plurality of outcome characteristics 47 simultaneously. Program creator/updater 23 can also automatically updates internal state 59 based on winners 53 of the auction for each of advertising slots 51, and update computer-readable auction programs 43 based on internal state 59 and prices 63 paid by winners 53 for each of advertising slots 51.

Referring now to FIG. 2, winner determination processor 21 can include first bidder subset processor 27 for determining first set 61 of bidders 19 based on computer-readable user input 49, and second processor 29 for determining subset 55 of first set 61, including at most k² bidders. Subset 55 can include the k bidders with a highest expected revenue for each of advertising slots 51 based on computer-readable auction programs 43. Winner determination processor 21 can further compute, for each of advertising slot 51, k bidders 19 for advertising slot 51 having the highest expected revenue by computing, for each output characteristic 47 for bidder 19, the expected revenue for each output characteristic 47 if the condition holds, and if bidder 19 were placed in the advertising slot 51, and summing the expected revenue over output characteristics 47 for bidder 19. For example, winner determination processor 21 can compute the highest expected value of bid 45 made by bidder 19 by (a) determining a first amount by multiplying bid 45 for a click by a click likelihood that bidder 19 receives the click if placed in advertising slot 51, (b) determining a second amount by multiplying bid 45 for a purchase by a purchase likelihood that bidder 19 receives a purchase if placed in advertising slot 51, and (c) adding the first amount, the second amount, and bid 45 by bidder 19 for advertising slot 51. Winner determination processor 21 can further include a maximum weighted matching algorithm processor 31 for determining from subset 55, a bipartite graph. The nodes of the bipartite graph include bidders 19 from subset 55 and k advertising slots 51. Each edge of the bipartite graph connects one bidder i of subset 55 to one slot j of advertising slots 51. Each of the edges is labeled by the expected revenue of bid 45 of the bidder i, if the bidder i were placed in the slot j. Winner determination processor 21 can further apply a maximum weighted matching algorithm to the bipartite graph to determine winner 53 of the auction for each of advertising slots 51.

Referring again to FIG. 1, system 100 can still further include pricing processor 13 for assigning a price 63 to each advertising slot 51 based on the highest expected revenue, and charging price 63 to winner 53 of advertising slot 51. User interface 11 can receive computer-readable user input 49 from a user of a service 67 provided through an Internet 65 connection. Service 67 can be, for example, an Internet search, an Internet game, or an Internet directional system. Bidders 19 can receive and provide all information to system 100 through an Internet 65 connection or other electronic communications means. Program creator/updates 23 can, for each of advertising slots 51, partition bidders 19 from subset 55 into subset groups having subset group bidders, according to an amount by which computer-readable auction programs 43 associated with each of the subset groups changes bid 45 for advertising slot 51. Program creator/updates 23 can also, for each advertising slot 51 and each subset group, update bid 45 made by subset group bidders by changing, by a pre-selected amount, a shared base value that is added to bid 45 of each subset group bidder, and can maintain the subset groups over time by moving at least one subset group bidder from at least one subset group to at least one other subset group when a monotonic input variable is greater than the value of output characteristic 47 of computer-readable auction program 43 associated with the subset group bidder that changes when the subset group bidder is winner 53 of advertising slot 51 in the auction.

Referring now to FIG. 3, method 150 for an auction for advertising slots 51 can include, but is not limited to including, the step of providing computer-readable auction program template 41 to bidder 19. Computer-readable auction program template 41 can include, but is not limited to including, output characteristics 47 with conditions. Method 150 can also include the steps of receiving an instantiated computer-readable auction program template 41 including bids 45 for output characteristics 47 and conditions, and forming computer-readable auction program 43 from the instantiated computer-readable auction program template. Computer-readable auction program 43 can include an advertising slot bid for advertising slot 51, where the advertising slot bid is computed from bids 45 for output characteristics 47 for advertising slot 51. Method 150 can further include the step of receiving computer-readable user input 49, determining, from computer-readable auction programs 43 and computer-readable user input 49 winner 53 of the auction for each of advertising slot 51. The step of determining winner 53 can include, but is not limited to including, the steps of choosing subset 55 of up to k² bidders, k bidders for each k advertising slot 51, from the pool of bidders 19, where k is the number of the advertising slots 51, and choosing, from subset 55, winner 53 for each of k advertising slots 51 based on the advertising slot bid and based on computer-readable user input 49. Method 150 can still further include the step of displaying advertisement 57 in each advertising slot 51. Advertisement 57 is associated with winner 53 of advertising slot 51. Computer-readable auction program template 41 can include, but is not limited to including, an accommodation such that each bidder 19 can bid on a plurality of outcome characteristics 47 simultaneously. The function to compute the advertising slot bid is the sum of bids 45, if any, associated with outcome characteristics 47 for which the conditions hold. Outcome characteristics 47 can include, but are not limited to including, advertising slot position, clicks, and purchases. Method 150 can include the step of automatically updating internal state 59 based on winner 53 of the auction for each advertising slot 51 and prices 63 paid by winners 53 of each advertising slot 51. The step of choosing subset 55 of up to k² bidders can include, but is not limited to including, the steps of determining first set 61 of bidders 19 based on computer-readable user input 49, and determining subset 55 of up to k² bidders by determining for each of k advertising slots 51, as a subset of first set 61, subset 55 associated with a highest expected revenue associated with computer-readable auction programs 43 associated with up to k² bidders. Method 150 can still further include the steps of computing, for each advertising slot 51, k bidders 19 having the highest expected revenue by computing, for each output characteristic 47 for bidder 19, the expected revenue for output characteristic 47 if bidder 19 were placed in advertising slot 51, and summing the expected revenue over output characteristics 47 for bidder 19. Method 150 can still further include the steps of assigning price 63 to each of advertising slots 51 based on the highest expected revenue, and charging price 63 to winner 53 of advertising slot 51.

The step of choosing winner 53 can include, but is not limited to including, the step of determining from subset 55, a bipartite graph. The nodes of the bipartite graph include bidders 19 in subset 55 and k advertising slots 51. Each edge of the bipartite graph connects one bidder i of the subset 55 to one slot j of advertising slots 51. Each of the edges is labeled by the expected value of bid 45 of the bidder i, if the bidder i were placed in the slot j. The step of choosing winner 53 can further include the step of applying a maximum weighted matching algorithm to the bipartite graph to determine winner 53 of the auction for each of advertising slots 51. The step of receiving computer-readable user input 49 can include, but is not limited to including the step of receiving computer-readable user input 49 from a user of service 67 provided through Internet 65, where service 67 can be, for example, but not limited to, an Internet search, an Internet game, or a direction providing application.

Method 150 can further include the step of, for each advertising slots 51, partitioning bidders 19 from subset 55 into subset groups as subset group bidders according to an amount by which computer-readable auction programs 43 associated with each of the subset groups change bid 45 for advertising slot 51. Method 150 can also include the step of, for each advertising slot 51 and each subset group, updating bid 45 made by the subset group bidders by changing, by a pre-selected amount, a shared base value that is added to bid 45 of each of the subset group bidders. Method 150 can still further include the step of maintaining the subset groups over time by moving at least one of the subset group bidders from at least one of the subset groups to at least one other of the subset groups when a monotonic input variable is greater than the value of output characteristic 47 of computer-readable auction program 43 associated with the subset group bidder that changes when the subset group bidder is winner 53 of advertising slot 51 in the auction.

Referring now to FIGS. 1 and 3, method 150 (FIG. 3) of the present embodiment can be, in whole or in part, implemented electronically. Signals representing actions taken by elements of system 100 (FIG. 1) can travel over electronic communications media. Control and data information can be electronically executed and stored on computer-readable media. System 100 (FIG. 1) can be implemented to execute on a node 25 (FIG. 1) in a communications network or via the Internet 65 (FIG. 1). Common forms of computer-readable media can include, but are not limited to, for example, a floppy disk, a flexible disk, a hard disk, magnetic tape, or any other magnetic medium, a CDROM or any other optical medium, punched cards, paper tape, or any other physical medium with patterns of holes or ink or characters, a RAM, a PROM, and EPROM, a FLASH-EPROM, or any other memory chip or cartridge, a carrier wave, or any other medium from which a computer can read.

In the following discussion, theoretical background and examples of the usage of system 100 are provided. Herein, predicates can be used by the bidders, also referred to herein as advertisers, that indicate whether or not the outcome has one of these desired properties:

Slotⱼ, indicating that the advertiser gets slot j, for j in {1, . . . , k}, with k being the number of advertising slots.

Click, indicating that the user clicked on the advertiser's ad.

Purchase, indicating that the user made a purchase via a link from the advertiser's ad.

Referring now to FIGS. 4A and 4B, the advertiser can associate a value with each truth assignment to these predicates, as depicted in FIG. 4A. Bids can be represented as OR-bids on Boolean combinations of predicates, that is, the advertiser can fill in a bids table where each row corresponds to a Boolean formula of predicates and the amount that the advertiser is willing to pay if the formula is true. If multiple formulas are true, the advertiser can be charged the sum of the corresponding amounts. For example, the bids table depicted in FIG. 4B indicates that the advertiser is willing to pay 0.05 cents if the user makes a purchase, 0.02 cents if the ad is displayed in either positions one or two, and 0.07 cents if the user makes a purchase and the ad is displayed in positions one or two.

Referring now to FIG. 4C, for example, advertiser-specific variables 211 related to keywords can be stored in a keyword table, as depicted in FIG. 4C, that is private to each advertiser. Each tuple in the keyword table can correspond to a bid for a keyword in which the advertiser is interested. The attributes of the tuple can contain, among other things, the formula for the bid, a keyword's relevance score in the search query, the return on investment that this keyword has provided the advertiser, the maximum amount that the advertiser is willing to bid on a click by a user who searched for this keyword, and the amount of money that the advertiser is currently bidding for the keyword. The Internet application can update the return on investment for a keyword each time a user searches for the keyword and then clicks on the advertiser's ad. The computer-readable auction program can be stored proximate to its private tables to improve locality. Since bidding programs use private tables and read-only shared tables, they do not interact with each other when they are triggered by a new search query. Hence they can be distributed across several machines and run in parallel if necessary.

Continuing to refer to FIG. 4C, for example, in the situation where the Internet application is an Internet search provider, an exemplary advertiser can combine dynamic ROI with bidding on two features—clicks and the top slot—and also with receiving clicks for two keywords, “boot” and “shoe”. Further, the advertiser may want to be perceived as the leading supplier of boots and may be willing to pay extra to be shown in the top slot if the search query is highly relevant to boots. Still further, the advertiser can have a goal to maintain a target spending rate. A ROI equalizing heuristic can try to dynamically allocate spending across the different keywords and bids. If the advertiser's current spending rate is lower than the target spending rate, the advertiser can increase the bids on keywords that have the highest return on investment. If the advertiser's spending rate is higher than the target spending rate, the advertiser can decrease the bids on keywords that have the lowest return on investment. Return on investment of a bid is the total value gained from the keyword (e.g., number of clicks received in the top slot times the amount the advertiser values a click in the top slot) divided by the amount spent so far on it.

Following is a program that illustrates the ROI equalizing heuristic. Line 1 creates a trigger that waits for a new query to be inserted into the query table, indicating that a new auction is taking place. If there has been underspending (line 3), the advertiser increases his tentative bids for all relevant keywords that have provided the highest ROI, taking care not to increase the bid past its maximum value (lines 4-10). Similarly, lines 13-19 decrease the advertiser's bids for relevant keywords with the lowest ROI if there has been overspending (line 11), taking care not to decrease the bid below zero. Next, the advertiser updates the values in the bids table with the sum of tentative bids for the corresponding formulas for all sufficiently relevant keywords, namely, those with a relevance score higher than 0.7 in the user-submitted search query (lines 22-27). For example, if a keywords table is as depicted in FIG. 4C after running lines 1-20, then the output bids table will be as depicted in FIG. 4D.

| | |
|---|---|
| 1 | CREATE TRIGGER bid AFTER INSERT ON Query |
| 2 | { |

| | |
|---|---|
| 3 | IF amtSpent / time < targetSpendRate THEN |

| | |
|---|---|
| 4 | UPDATE Keywords |
| 5 | SET bid = bid + 1 |
| 6 | WHERE roi = |

| | |
|---|---|
| 7 | ( SELECT MAX( K.roi ) |

| | |
|---|---|
| 8 | FROM Keywords K ) |

| | |
|---|---|
| 9 | AND relevance > 0 |
| 10 | AND bid < maxbid; |

| | |
|---|---|
| 11 | ELSEIF amtSpent / time < targetSpendRate |
| 12 | THEN |

| | |
|---|---|
| 13 | UPDATE Keywords |
| 14 | SET bid = bid − 1 |
| 15 | WHERE roi = |

| | |
|---|---|
| 16 | ( SELECT MIN( K.roi ) |

| | |
|---|---|
| 17 | FROM Keywords K ) |

| | |
|---|---|
| 18 | AND relevance > 0 |
| 19 | AND bid > 0; |

| 20 | ENDIF; |
|---|---|
| 21 | |
| 22 | UPDATE Bids |
| 23 | SET value = |

| | |
|---|---|
| 24 | ( SELECT SUM( K.bid ) |

| | |
|---|---|
| 25 | FROM Keywords K |
| 26 | WHERE K.relevance > 0.7 |

| | |
|---|---|
| 27 | AND K.formula = Bids.formula ); |

| | |
|---|---|
| 28 | } |

The present embodiment optimizes the winner-determination computation. In general, the winner-determination problem is to compute the allocation of slots to advertisers that results in the highest expected revenue for the Internet application, under the assumption that advertisers actually pay what they bid. Given the advertisers' bids on, for example, clicks, purchases, and slot positions as specified in advertiser bids tables, and the probabilities that the formulas in the bids tables are true in the final outcome, the set of all possible outcomes that describe which slot was allocated to which advertiser together with which advertisers received clicks and purchases can be determined. The probabilities of clicks and purchases can depend on the allocation of slots to advertisers. For example, ads placed at the top can be considered more likely to be noticed and clicked on than those placed in the middle of the page. For the purposes of this analysis, it is assumed that the probability that a user clicks on the slot allocated to a given advertiser depends only on the slot position, and that the probability that a purchase of the advertiser's goods/services is made depends only on whether the user clicks on the advertiser's slot. Further, for the purposes of this analysis, it is assumed that these probabilities can be computed or estimated for each advertiser and each slot allocated to that advertiser. Because a complete set of the probabilities of all possible formulas for each advertiser is exponential in the number of features, the set of probabilities could be stored in a database separate from the run-time system. Further, the database could store the probabilities for the formulas in the bidding programs and keyword tables, since these are the only probabilities that are used. Still further, the probabilities can be partitioned by advertiser and could be stored with the advertiser's bidding program and private tables to improve locality.

A computer-readable auction program's output is an OR-bid represented by a bids table whose rows contain bids of the form “Pay $d₁ for E₁”, . . . , “Pay $dₘ for Eₘ”, where E₁, . . . , Eₘ are Boolean combinations of the Slotⱼ, Click, and Purchase predicates described herein. For any slot allocation, there can be a distribution on outcomes, conditional on that slot allocation. Each formula Eᵢ can be identified with an event on the set of possible outcomes, namely, the set of outcomes in which Eᵢ is true. An event as defined herein is m-dependent if there are at most m advertisers such that probability of the event given any allocation depends only on the placement of those m advertisers. That is, an event is m-dependent if it is independent of the advertising slots assigned to all but m advertisers. For example, the event that a given advertiser gets a click is 1-dependent, since it has herein been assumed that the probability of an advertiser getting a click depends only on the advertising slot position of that advertiser. Similarly, the event that a given advertiser is in a particular slot position is 1-dependent, since it depends only on the slot assigned to that advertiser. However, given two advertisers, the event that one gets a particular position, for example, the first position in a list, and the second gets, for example, the last position in the list, is 2-dependent, since the event depends on the advertising slots assigned to both advertisers.

It is assumed that the representation of each m-dependent event includes the labels of the m advertisers on whose slot assignment the event depends. The following theorem says that winner determination is tractable for 1-dependent events. For OR-bids that contain formulas corresponding to 1-dependent events, the winner-determination problem is in polynomial time. The proof of this theorem follows. With respect to a bid of $d on E, where E is a formula corresponding to a 1-dependent event that depends on the slot assigned to only one advertiser, for example, i, if advertisers pay what they bid, then, in all outcomes, this bid contributes exactly the same amount to the revenue as the OR-bid of $d on E Λ Slot₁ⁱ, $d on E Λ Slot₂ⁱ, $d on E Λ Slotₖⁱ, and $d on E Λ (Λⱼ-Slotⱼⁱ), where Slotⱼⁱ is a propositional variable that is true if and only if advertiser i gets slot j. This is because Slot₁ⁱ, . . . ,Slotₖⁱ correspond to mutually exclusive events, given that the allocations are restricted to at most one slot per advertiser. Therefore, a table of advertisers versus slots can be filled out where the entry for the ith advertiser and the jth slot is the sum of the total expected revenue from bids on formulas of form E Λ Slotⱼⁱ, assuming that advertisers pay what they bid. If this table is interpreted as the edge-weight matrix of a bipartite graph between advertisers and slots, then the winner-determination problem is the problem of finding a maximum-weight bipartite matching for this graph, which can be done in polynomial time, and thus winner determination for bids represented by a bids table can be solved in polynomial time, since the assumptions specified herein guarantee that any Boolean combination of predicates in the set {Click, Purchase, Slot₁, . . . ,Slotₖ} corresponds to a 1-dependent event.

Further, the following theorem states that winner determination is APX-hard if bids are placed on formulas corresponding to 2-dependent events, such as the event that one advertiser is displayed above another. (APX is the class of NP optimization problems that have polynomial-time constant-factor approximation algorithms.) For OR-bids that contain formulas corresponding to 2-dependent events, the winner-determination problem is APX-hard. The winner-determination problem can be reduced to the maximum-weight feedback arc set problem by using bids on formulas corresponding to 2-dependent events to encode the edges in a given weighted directed graphs on advertisers. For any weighted directed graph on n advertisers, if w_{i,i′} is the weight of the edge from advertiser i to advertiser i′, and Slotⱼⁱ is the propositional variable that is true if and only if advertiser i gets assigned slot j, and for two advertisers i and i′, E_{i>i′} is shorthand for Λⱼ(Slotⱼⁱ Λ ((Λ_{j′>j}Slot_{j′}^{i′}) Λ (Λ_{j′}-Slot_{j′}^{i′})), which corresponds to the event that advertiser i gets a slot and is placed above advertiser i′ who may or may not get a slot, then E_{i>i′} corresponds to a 2-dependent event, since it depends on the slots assigned to advertisers i and i′. If each advertiser i places the following bids: for each i′≠i, bid w_{i,i′} on E_{i>i′}, then, assuming advertisers pay what they bid, revenue of w_{i,i′} will be generated if and only if advertiser i is placed above advertiser i′. Thus, winner determination is equivalent to the problem of finding the maximum-weight feedback arc set over all size-k subgraphs, which is APX-hard in n and k. In this analysis, each formula in an advertiser's OR-bid corresponds to a 2-dependent event. This does not preclude the set of all advertisers that these events depend on from being large (e.g., an advertiser's OR-bid could contain n−1 formulas of the form E_{i>i′} for each i′≠i). However, the analysis described herein provides an NP-hardness result even if the OR-bids are restricted so that all the events corresponding to formulas depend on at most two other advertisers in total (e.g., if each advertiser's OR-bid contains at most two formulas of the form E_{i>i′} with i′≠i). This is because the maximum-weight feedback arc set problem is NP-hard even if the input graphs have degree three.

Referring now to FIGS. 5A and 5B, the Hungarian algorithm finds the best matching and therefore performs winner determination in time O(nk(n+k)), where n is the number of advertisers and k is the number of slots, which is quadratic in n. Since n can be quite large (possibly in tens to hundreds of thousands), to make the problem scalable, one possible solution is that the algorithm could be linear in n. A scalable winner-determination algorithm can take advantage of the fact that k, the number of slots, can be quite small (for example, less than 20) compared to n, the number of advertisers, A modified Hungarian algorithm O(nk log k+k⁵) can be achieved by considering only those advertisers whose values are in the top k highest for some slot. That is, for each slot, the k advertisers who would produce the top k expected revenue if placed in that slot are considered. Further, the union of these advertisers over all the k slots is taken, and the bipartite subgraph containing only these advertisers along with all the k slots is considered. The maximum-weight bipartite matching problem is solved for this reduced bipartite graph. As an example, the expected revenue matrix depicted in FIG. 4E illustrates two slot positions available and four advertisers. The top two expected revenues for the first slot come from Nike and Adidas, while the top two expected revenues for the second slot come from Adidas and Reebok. The corresponding edges in the original bipartite graph between advertisers and slots have been depicted in bold in FIG. 5A. This bipartite graph is then reduced to contain only those advertisers with an adjacent bold edge as depicted in FIG. 5B. It is shown that the maximum matching for a more general problem occurs for this smaller problem, since, if a maximum matching in the more general problem assigned a slot to an advertiser who was not among the top k² bidders for that slot, that slot can be assigned to one of these top k² bidders who is not assigned any slot. Note that, since there are only k−1 other slots, at least one advertiser in the top k is guaranteed to remain unassigned.

Finding the relevant advertisers takes time O(nk log k) because, for each slot, the top k² bidders can be found for that slot in time O(k+n log k) by maintaining a priority heap of size at most k. There are at most k² such advertisers, since in the worst case we will have a distinct set of k advertisers for each of the k slots. Hence, running the Hungarian algorithm on the reduced graph takes time O(k⁵) for a total running time of O(nk log k+k⁵). To achieve parallelism, beyond the inherent parallelism in the system, since the bids are collected from advertisers in a distributed way, k networks of computers each in the form of a binary tree of height O(log n) with n leaves are constructed. The maximum matching in time O(k log n+k⁵) as follows can be computed as follows. For each slot j, consider the jth binary tree network, which will ultimately compute the top k² bidders for that slot at the root:

1. The ith leaf node in the jth network starts out with the expected revenue from assigning slot j to advertiser i.

2. Each internal node gathers the top k² bidders (along with their corresponding bids) from its two children, and combines them into a single list of top k² bidders. This takes time O(k) for each of the O(log n) levels of the tree, since each level of the tree works in parallel.

3. The root nodes in each of the j-networks take the union of their lists of bidders and compute the maximum-weight matching of these bidders with the k slots using the Hungarian algorithm. This takes time O(k⁵), since there are k slots and at most k² bidders considered.

Sequential processing can be mixed with parallel processing by running more than one program sequentially on each machine, computing the top k bids, and then aggregating using a tree network as described herein. For example, for a binary tree network with p nodes, then the total running time becomes O((n/p)k log k+k log p+k⁵).

Finally the O(k⁵) part of the algorithm (i.e., the part resulting from running the Hungarian algorithm on the reduced bipartite graph) can be reduced to O(k²) using a parallel algorithm. The number of parallel processing units required is O(k⁵), which is independent of n.

To reduce processing time further, the assume that advertisers' computer-readable auction programs output bids on only Click Λ Slot₁, . . . , Click Λ Slotₖ. Bids on other formulas can be incorporated, since both Click and Purchase are assumed to be 1-dependent events. It is assumed that the only difference between the programs used by different advertisers is in the values of certain advertiser-specific parameters. More precisely, for each slot j in [k], if each advertiser's bids depends on a set of (numeric) parameters Xⱼ in a monotonic way, that is, if there is a monotonic function ƒⱼ:Xⱼ→R⁺ that takes as input a value for each parameter in Xⱼ and outputs a bid for a click in slot j, some subset of the parameters Yⱼ can be advertiser-specific, and these can vary from advertiser to advertiser (e.g., the amount that they value a particular keyword, the amount of budget remaining, etc.). These parameters Yⱼ can be updated by computer-readable auction programs that win the auction, and computer-readable auction programs can update their state. The rest of the parameters Zⱼ=Xⱼ\Yⱼ can be thought of as public global parameters, and are the same for all advertisers (e.g., the keyword scores associated with the user's search query, the time and date, the number of times the keywords in search query have appeared today). As an example, if advertisers all use the same general strategy of starting each day by bidding low and then gradually increasing their bids as the end of the day approaches, and they each start with a different amount and might increase their bids at different rates, the starting amounts and the rate of increase would be advertiser-specific parameters in Yⱼ, and the time of day would be a global parameter in Zⱼ. For each advertiser i and each slot j, the edge weight between advertiser i and slot j can be w_{i,j}×ƒⱼ(y_{i,j},zⱼ), where w_{i,j} is the probability of advertiser i getting a click in slot j, y_{i,j} in Yⱼ are the values of the advertiser-specific parameters, and zⱼ in Zⱼ are the values of the global parameters. If the maximum-weight matching can be solved in time O(nk log k+k⁵), under the assumptions above, the O(nk log k) portion that finds the top k² bidders for each slot can be further reduced as follows. For a given slot j, a list of bidders sorted by w_{i,j} can be stored and |Yⱼ| lists of bidders can be incrementally maintained, each sorted by one of the parameters in Yⱼ. A threshold algorithm, one that terminates when a certain threshold is achieved, with these lists can be run as input to find the top k advertisers with the highest values of w_{i,j}×ƒⱼ(y_{i,j},zⱼ). It is not necessary to maintain lists for the parameters in Zⱼ since all advertisers have the same value for these parameters. Since ƒⱼ is monotonic, the threshold algorithm is instance optimal for the class of algorithms that find the advertisers with the top k values of ƒⱼ(x_{i,j}) without making “wild guesses” (i.e., the algorithms must not access an advertiser until that advertiser is encountered via a sequential scan of one of the lists). Instance optimality means that, for any input, the threshold algorithm finds the top k values within a constant factor of the time it takes the fastest algorithm that avoids wild guess on that input. Given these top k advertisers for each slot, we take O(k⁵) further time to compute the winners as described herein. To maintain the sorted lists, once the k winners have been computed, their Yⱼ parameters are updated and accordingly their positions are updated in the sorted lists, which takes O(|Yⱼ|k log n) time.

If only programs that win the auction update their private state, processing time can be further reduced by restricting the set of advertisers and periodically evaluating the computer-readable auction programs of all the advertisers. If U_{i,j} and L_{i,j} be upper and lower bounds on the output bid of advertiser i's program for slot j, only those computer-readable auction programs i for which U_{i,j} is at least as high as the kth highest L_{i,j} value are considered. The system can maintain a partition the advertisers' programs into DefiniteLosers and PossibleWinners, keeping track of upper bounds on the expected revenues for all advertisers and of lower bounds on the expected revenue for just those advertisers in PossibleWinners. At every step, the partition is updated by running the following procedure:

1. Compute the expected revenue only for programs in PossibleWinners.

2. Compute the top k expected revenue amongst the exact bids from programs in PossibleWinners.

3. Update the upper and lower bounds for the expected revenue for the programs in PossibleWinners.

4. Update the upper bounds for advertisers in DefiniteLosers.

5. Move an advertiser from DefiniteLosers to PossibleWinners if her upper bound is at least as high as the kth-highest lower bound from PossibleWinners.

6. Move an advertiser from PossibleWinners to DefiniteLosers if her upper bound is less than the kth-highest lower bound from Possible Winners.

The programs in DefiniteLosers can be stored in a max-heap, prioritized by the upper bound for the expected revenue from that program, in order to perform steps 5 and 6 efficiently. If PossibleWinners is much smaller than DefiniteLosers, the major savings come from finding an upper bound that does not change if an advertiser loses the auction. This eliminates the need to perform step 4. As an example, if the inputs to the program are geographic relevance, temporal relevance, user profile relevance, keyword relevance, number of clicks received so far today, amount paid for clicks so far today, and daily budget remaining, and it is assumed that the output bid is increasing with respect to the first four parameters, the last three parameters do not change for losing bidders. Thus, as an upper bound, the value of the bidding function supplied with the maximum possible values for the relevance parameters and current values for the last three parameters can be used. For a lower bound, the minimum values for the relevance parameters that result in a non-zero bid can be supplied.

When all programs update state, not just the winners, in certain situations, it is possible to reduce the processing time. If many programs update state using an operation that maintains relative bid ordering, as long as certain conditions hold (namely, the bid is above zero and the spending rate is above the target spending rate), the heuristic will decrement its bid for a given keyword. Thus, if a decrement list can be maintained—that is, a list of computer-readable auction programs, sorted by their bids, that are currently decrementing their bids for a given keyword—explicitly decrementing each program's bid can be avoided by instead performing a single logical decrement in constant time. That is, the decrement list is associated with a single adjustment variable, initially zero. A computer-readable auction program's bid can then be the sum of the adjustment variable and the computer-readable auction program's stored bid. So, in order to decrement the bids of all programs in the list, the adjustment variable is decremented. The sorted order is maintained because all computer-readable auction programs in the list adjust their bids by the same amount. For example, suppose that many bidders are using the ROT heuristic described herein, each with possibly different target spending rates and maximum bids. The ROI heuristic eventually stops decrementing the bid and starts to increment it (if the spending rate drops below the target) or keep it constant (if the bid is zero) instead. At this point the program can be moved to an increment list or a constant list as appropriate (similar to a decrement list, except that the adjustment variable respectively increments or remains constant). To reduce the amount of checking the conditions for each program at every auction, such conditions can often be reduced to waiting for a shared monotonic variable (such as time, or the number of times a given keyword has occurred) to reach a critical value. For example, in the ROI heuristic, the spending rates of losing programs decreases with time, since their amount spent remains constant. The next “critical” time that a program would have to stop decrementing and start incrementing can be computed, assuming that the program continued to lose. Similarly, the number of auctions for given keyword necessary before its bid would be decremented to zero and it would have to remain constant at zero can be computed. A list of triggers for the relevant shared monotonic variables, sorted by critical value, can be maintained, that when activated move a bidding program to the appropriate increment, decrement, or constant list, and the appropriate new triggers can be inserted.

If the slot assigned to an advertiser for a small company is just below a very large and popular competitor, then it is likely that the competitor will receive a substantial portion of user clicks that might otherwise have gone to the smaller advertiser had the competitor not been present. Thus, the probability of receiving a click (or a purchase) could depend on which other advertisers display ads and in what advertising slot positions. To accommodate this possibility, the advertisers could be classified as either heavyweights (famous advertisers) or lightweights (relatively unknown advertisers). The probability that a given advertiser gets a click (or a purchase) can depend not only on the advertiser's slot position, but also on which slots have heavyweight advertisers and which slots have lightweight advertisers. Advertisers can place bids that depend on which slots get heavyweights and which slots get lightweights, in addition to placing bids on, for example, click, purchases, and slot positions as before. Thus, an advertiser might bid 0.03 cents if for slot two if there is a lightweight advertiser in slot one. Advertisers could place more complex bids, such as bidding on having no heavyweights within three slot positions above or below the advertiser's slot in addition to having no more than two heavyweights appear anywhere else. The representation of the probability distributions and valuations now become O(k2^{k-1}), and does not depend on n. For this situation, to solve the winner-determination problem, an assignment of slots to advertisers to maximize expected revenue (assuming advertisers pay what they bid) given these new valuations and distributions can be determined. For example the slots that get heavyweight advertisers in such a revenue maximizing assignment are can be termed heavyweight slots, and the remaining slots can be termed lightweight slots. The winner-determination problem can be solved by solving two disjoint maximum-weight bipartite matching problems: one matching the heavyweight advertisers to the heavyweight slots, and the other matching the lightweight advertisers to lightweight slots. If these solutions are determined for each possible way to choose heavyweight slots, the assignment that maximizes expected revenue over all possible assignments can be found. Moreover, the maximum-weight bipartite matching problems for different choices of heavyweight slots can be solved independently and in parallel. Therefore, since there are 2^{k} ways to choose heavyweight slots, winner determination can be made in time O(2^{k}(n log k+k⁵)) in series, or in time O(n log k+k⁵) in parallel using 2^{k} processing units. Note that the number of parallel processing units is independent of the number of advertisers n.

If, during a search-related auction, the search keyword interests advertisers who are not competing with each other for sales, for example, a keyword like “games” might interest both sports stores and a video game stores, a video game advertisement would probably not drain clicks away from a sports store advertisement placed just below it as much as it would drain clicks from another video game advertiser. Thus, if the advertiser are typed (e.g., ‘video game store’, ‘sports store’, etc.), and if advertisers of the same type are displayed, they could affect each other's click-through and purchase rates, whereas advertisers of different types may not affect each others click-through and purchase rates. The probability that a given advertiser gets a click (or a purchase) can depend on the advertiser's slot position as well as on the set of slots that have advertisers who are of the same type. Advertisers can place bids on the set of slots that are assigned to advertisers of their own type, in addition to placing bids on, for example, click, purchases, and slot positions. Thus, an advertiser might bid 0.03 cents for slot two and if there is a competitor in slots one or three. Typically, an advertiser would bid less for a slot assignment if there were other advertisers of the same type, since these are the advertisers that represent the most competition. In general, the storage requirement for each advertiser's valuations and click and purchase probability distributions is O(k2^{k-1}), similar to the heavyweight-lightweight model. For winner determination, the technique employed in computing winners for the heavyweight-lightweight model can be generalized. That is, for each possible way to assign types to slots, a separate winner-determination computation can be run, having a running time of O(g^{k}(n log k+k⁵)) in series, or in time O(n log k+k⁵) in parallel using g^{k} processing units, where g is the number of types of advertisers bidding in the auction.

Referring now to FIGS. 6 and 7, if advertisers can receive multiple slots, and each slot is assigned to the advertiser with the highest expected revenue in that slot, advertisers might value winning both of two adjacent slots more than the sum of the values of winning each slot alone. The reason for this is that adjacent slots give advertisers the advantage of being able to combine the two slots to create a larger ad, perhaps even using a larger font size, thus making their advertisement stand out more. In such case, the value of winning multiple adjacent slots in not additive with respect to the value of winning the individual slots by themselves. Furthermore, the click-through rate of such an ad in the larger combined slot is no longer a simple combination of independent click-through rates from the two adjacent slots. The system of the present embodiment can accommodate valuations and click and purchase probability distributions on ads that span blocks of adjacent slots. A layout as depicted in FIG. 6 of a one-dimensional array of advertisement slots is termed herein as a list layout. In this setting, advertising blocks are slot intervals, comprising of a set of one or more adjacent slots in the list. If m is the number of advertising blocks, then m in θ(k²), where k is the number of slots. Advertisers can place OR-bids on these slot intervals instead of on individual slots. Accordingly, predicates of the form Slot_{x-y} for each 1≦x≦y≦k that the advertiser can use in their OR-bid table, in addition to the Click and Purchase predicates described herein can be added. The predicate Slot_{x-y} is true if and only if the advertiser gets all the slots between and including slots x and y. An example OR-bid table is depicted in FIG. 7, where the advertiser is willing to pay $2 for slot one alone, $1 for slot two alone, but $4 if the advertiser gets both slots one and two. Separate click and purchase probabilities are maintained for each advertiser in each slot interval. Therefore, the space requirements for storing an advertiser's bids and click- and purchase-probabilities increase from O(k) to O(k²). The winner-determination problem can be solved as follows. The advertiser who would provide the highest expected revenue if displayed in each slot interval is associated with that slot interval. This association process takes time O(nm), where m is the number of blocks or slot intervals. A weighted undirected graph is constructed in which each node corresponds to a slot interval, and the weight of the node is the expected revenue associated with the advertiser associated with that slot as computed above. Two nodes can have an edge between them if and only if the intervals corresponding to the nodes intersect. By definition, this graph is an interval graphs, that is, a graph whose nodes represent intervals, with an edge between two nodes whose corresponding intervals overlap. If there were a maximum-weight independent set of this graph, then the slot intervals corresponding to nodes in this independent set could be assigned to the highest advertisers associated with these intervals. Such an allocation could be feasible, since the independent set corresponds to a set of mutually disjoint intervals, and hence no slot would be assigned to more than one advertiser. Furthermore, such an allocation could be a solution to the winner-determination problem, since a maximum-weight independent set corresponds to an allocation with maximum expected revenue. Thus, the winners can be determined by finding the maximum-weight independent set of an interval graph containing O(k²) nodes. Finding a maximum-weight independent set of the intersection graph is equivalent to finding a maximum-weight clique of the complement of the intersection graph. This is the graph whose nodes are blocks and whose edges connect nodes corresponding to disjoint blocks, termed a non-intersection graph. Directions can be imposed on the edges of the non-intersection graph such that they satisfy transitivity. This can be one on a list layout by directing the edge between two disjoint intervals from the lower interval to the higher interval, assuming, without loss of generality, that the list is oriented vertically. Then the winner determination problem can be solved in time O(m³), where m in θ(k²) is the number of blocks, using the following algorithm. Each node is considered in an order corresponding to any linearization of the topological ordering. For each such node, the maximum-weight clique in the subgraph induced by all nodes considered up to this point and containing this node is computed. This clique can be found by finding the maximum-weight clique from the set of cliques obtained by unioning the node under consideration with each of the cliques associated with the preceding nodes that have edges into the node under current consideration. Note that transitivity guarantees that the union of the node and a clique containing a preceding node is also a clique. Once all nodes have been encountered, a clique of overall maximum weight in the non-intersection graph can be found by considering the clique associated with each node and picking the one with the highest weight. Furthermore, if the slot intervals sorted by their endpoints are stored, then a maximum-weight independent set can be found in time O(m)=O(k²); hence, winner determination takes time O(nk²).

Referring now to FIGS. 8A-8C, the layout can be other than a list layout, for example, instead of displaying a vertical list of ads on the right-hand side of the page, the Internet application might display ads all around the border of the page, as in FIG. 8A. Alternatively, the Internet application might display ads in a grid of slots, as in FIG. 8B, or a mixture, as in FIG. 8C. The graph whose nodes are slots and whose edges connect nodes corresponding to adjacent slots is termed herein a layout graph of the slots. A block of slots is any set of slots corresponding to a connected subgraph of the layout graph, where m is the number of such blocks. An intersection graph of the blocks that the advertisers can bid for can be constructed. This is the graph whose nodes represent blocks and whose edges connect nodes corresponding to blocks that intersect. When each block has been associated with the advertiser who produces the highest expected revenue in that block, the solution to winner determination is given by finding a maximum-weight independent set of the intersection graph and then assigning each block in this independent set to its associated advertiser.

Continuing to refer to FIGS. 8A-8C, the layout can be termed a ring layout if the layout graph is a simple cycle, as in FIG. 8A. In this case, the number of blocks, m is θ(k²), and the intersection graph of blocks is a circular arc graph (i.e., one which is the intersection graph of arcs of a circle), for which finding the maximum-weight independent set is known to be solvable in time O(m²). Thus, winner determination for a ring layout can be solved in time O(nk⁴). The layout can be termed a grid layout when the layout graph is a k₁×k₂ grid, as depicted in FIG. 8B, and a tree layout when the layout graph is, for example, as depicted in FIG. 8C. If there a small number of blocks (e.g., if at least one dimension of the grid is small), then an O(2^{m})-time brute force solution can be used, where m is the number of blocks, resulting in an O(nm+2^{m})-time winner determination algorithm. If the assignment of blocks is restricted to ones where the blocks form an axis-aligned recursive subdivision of the grid, then winner determination can be achieved in polynomial time. An independent set of a grid's intersection graph is termed herein a subdivision set if the blocks corresponding to the nodes in the independent set form an axis-aligned subdivision of the grid. To solve winner determination, a maximum-weight subdivision set for the intersection graph can be found using a dynamic programming algorithm that computes maximum-weight subdivision set for all rectangular sub-grids in increasing order of area. To find the maximum-weight subdivision set of a given sub-grid, all O(k₁+k₂) ways to split the sub-grid into two pieces are tried, and the subdivision sets of the two smaller sub-grids formed by the split are combined. Since there are O(k₁²k₂²) rectangular sub-grids of the original grid, this algorithm runs in time O((k₁k₂)²(k₁+k₂)). In a tree layout, there are exponentially many blocks since, for example, in a star tree, every subset of leaves defines a connected subgraph of slots when connected through the central node. Therefore, we restrict our attention to trees with bounded degree d. However, even in trees with bounded degree, there can still be exponentially many blocks. For example, in a full binary tree, the number of connected subgraphs containing the root is Ω(2^{k/2}), because each subgraph containing the root is the result of taking the original binary tree and subtracting off various subtrees, each of which corresponds to a disjoint interval of the θ(k/2) leaf nodes; and there are Ω(2^{k/2})-many different ways to partition the leaf nodes into disjoint intervals. Therefore, in order to limit the number of blocks, blocks containing at most b slots are considered. Then the number of blocks will be O(kd^{b}), since each slot can belong to no more than d^{b} blocks, given that the degree of the tree layout graph is bounded by d and the block size is bounded by b. Thus, the intersection graph of the blocks has a natural tree decomposition given by associating each node in the tree layout graph with the set of blocks containing that node. This tree decomposition yields a treewidth of O(d^{b}), since each slot can belong to no more than d^{b} blocks. For a graph with O(m) nodes and O(d^{b}) treewidth, a maximum-weight independent set can be found in time O(2^{x}m)=O(2^{x}kd^{b}), where x=d^{b}. Thus, the total time for winner determination for a tree layout with degree bound d and block size bound b is O(kd^{b}(n+2^{x})).

With respect to in-game advertising in Internet games, the billboard ads shown to a player do not have to be generated statically. The game can select which ad to display dynamically (via an auction) as long as it does so before the billboard is rendered on the player's screen. In-game advertising considerations include the acceptability of two players looking at the same virtual billboard simultaneously and seeing different ads. Thus, the game could display different ads for different players even in a shared environment, making in-game advertising amenable to targeted advertising. Advertisers can bid differently for different player profiles. Accurate statistics about players' in-game activities can be maintained by game servers in order to track players' progress. These statistics can be used to get a picture of the type of player. Also, certain types of internet games can contain social networks such as guilds (large groups of players who share similar goals or virtual professions), parties (smaller groups of players who go on quests together), and personal contact lists (other players who are friends of a player and who often socialize with the player in the game). These social networks can be mined to predict whether or not a new player falls into a certain market segment based on whether or not his friends and fellow guild-members do. Furthermore, in-game chat can be logged and mined for keywords that indicate potential interest in the products that the advertisers sell. In-game advertising considerations can further include virtual billboard impressions. The location of the billboard within the virtual world can affect the amount of impact its ads can have. Billboards placed at eye-level within the gameworld can have greater impact. Too many billboards cluttered together can reduce the amount of impression that an ad makes. Beyond spatial positioning of the billboard, gameplay-related distractions present at the location can also affect impressions. For example, if a billboard is placed in an area where there is a lot of intense and immersive gameplay (such as combat with a monster), then the player is not likely to pay much attention to the ad displayed on that billboard. Each billboard can be assigned a prominence score, based on the visibility of its spatial location and on the amount of distractions present at the location (e.g., other billboards, enemies, etc.). The prominence score can be calculated just before the auction for a billboard (or set of billboards) begins based on the number of enemies near the billboard at the time the player enters a trigger area, and based on the visibility the billboard would have for a player approaching from the trigger area. In-game advertising considerations can still further include ad exposure. Even if an ad is placed on a prominent billboard with few distractions around it, the player may still not see the ad because the player may be facing away from the ad. However, how long the ad is in the player's field of vision, whether or not the player's view of the ad was obstructed by another object, what angle the ad was viewed from, whether the player was engaged in some other activity (e.g., cycling through his inventory) while the ad was in view, etc., can be measured. These measurements can be combined into a single exposure score that is accumulated over the course of the game. Note that the exposure score is known only after the player has quit the game and is therefore uncertain at the time of the ad auction. In-game advertising considerations can also include player engagement. Aiming/targeting systems that can be built into Internet games can be used to determine player engagement. Players can, for example, bookmark ads by “shooting” at them. The number of shots fired can indicate how much the ad interests the player. Upon quitting the game, the player can then be presented with a splash screen containing the list of all the bookmarked ads, sorted by the extent of the player's interest.

In the setting of advertising on in-game billboards, the billboards are analogous to slots. The exposure and engagement scores are similar to clicks and purchases in that they are unknown at auction time, and therefore the game must maintain distributions of exposure and engagement scores for each billboard. These distributions can be based on historical data. An auction for a set of billboards is run when a player enters their trigger area. Advertisers can submit programs to bid for billboards, and these programs can be given access to variables relevant to the player's profile and to the current prominence scores for the set of billboards. Thus, instead of bidding on, for example, slots, clicks, and purchases, the in-game computer-readable auction programs can output bids on billboards as well as on intervals of exposure and engagement scores. For examples, an advertiser can bid 0.03 cents for the second-most prominent billboard if exposure ends up being greater than 0.8 and engagement ends up being greater than 0.6. This would be represented by a bids table as shown in FIG. 9. The game can compute winners so as to maximize the expected revenue assuming that advertisers pay what they bid. If the only billboard that affects the exposure and engagement scores for an advertiser is the billboard to which the advertiser is assigned, then winner determination can be solved efficiently by processes described herein.

Another possible venue for Internet advertising is an Internet mapping system such as MAPQUEST®. In a map-route search, users submit a start address and a destination address; then the search provider returns a page displaying driving directions from the start to the destination, along with a map displaying this route. Ads on map-route search result pages can be displayed by highlighting segments along the route such that when the user clicks on or hovers over a highlighted segment, an advertiser's ad can be displayed in a balloon. Highlighted segments that are adjoining each other can be distinguished by the use of different colors. Moreover, the advertisers' ads can also be displayed alongside the appropriate set of steps in the driving directions. In the system of the present embodiment, advertisers can specify complex conditions, such as, for example, being a certain number of miles away from the start or destination address. For example, a gas station could choose to advertise only on map routes that start about three hundred miles away and pass by the gas station. In addition to specifying addresses, advertisers could also specify search phrases, such as “beach” or “museum”, which could then be matched to addresses. In this way, a swimwear store in an inland town could advertise on map searches from that town to any location near a beach. To apply the present embodiment to a map route, the route can be partitioned into a sequence of unit segments. These unit segments are analogous to slots in a list layout. Advertisers can then bid on blocks (i.e., intervals) of unit segments. In addition to allowing advertisers to bid on segments, advertisers can set different bids based on the number of competing advertisers of the same type displayed on the map. For example, a swimwear store might bid much higher if it is the only swimwear store displayed on the route, since one swimsuit is usually enough for most people.

Although the teachings have been described with respect to various embodiments, it should be realized these teachings are also capable of a wide variety of further and other embodiments.

What is claimed is:

1. A method for providing an auction for advertising slots comprising the steps of:
providing a computer-readable auction program template to at least one bidder, the computer-readable auction program template including output characteristics with conditions;
receiving an instantiated computer-readable auction program template including bids for at least one of the output characteristics subject to the conditions;
forming at least one computer-readable auction program from the instantiated computer-readable auction program template, the computer-readable auction program including an advertising slot bid for the advertising slot, wherein the advertising slot bid is computed from the bids for at least one of the output characteristics for the advertising slot;
receiving computer-readable user input;
determining, from the computer-readable auction programs and the computer-readable user input a winner of the auction for each of the advertising slots by the steps of:
choosing a subset of up to k² bidders, k bidders for each of the k advertising slots, where k is the number of the advertising slots; and
choosing, from the subset, a winner for each of the k advertising slots based on the advertising slot bid and based on the computer-readable user input; and
displaying an advertisement in each of the advertising slots, the advertisement being associated with the winner of the advertising slot.

2. The method as in claim 1 wherein the computer-readable auction program template comprises:
an accommodation such that each of the at least one bidders can bid on a plurality of the outcome characteristics simultaneously, and
wherein the function to compute the advertising slot bid is the sum of the bids, if any, associated with the plurality outcome characteristics for which the conditions hold.

3. The method as in claim 1 further comprising the step of:
selecting the outcome characteristics from a group consisting of advertising slot position, clicks, and purchases.

4. The method as in claim 3 further comprising the step of:
automatically updating an internal state based on said step of determining the winner of the auction for each advertising slot and prices paid by the winners for each of the advertising slots.

5. The method as in claim 1 wherein said step of choosing the subset of up to k² bidders comprises the steps of:
determining a first set of the at least one bidder based on the computer-readable user input; and
determining the subset of up to k² bidders by determining for each of the k advertising slots the k bidders that would yield the highest expected revenue if the k bidders were placed in each of the k advertising slots.

6. The method as in claim 5 further comprising the step of:
computing, for each of the advertising slots, the k bidders for the advertising slot having the highest expected revenue by computing, for each output characteristic for the bidder, the expected revenue for the output characteristic if the bidder were placed in the advertising slot; and
summing the expected revenue over the output characteristics for the bidder.

7. The method as in claim 5 further comprising the steps of:
assigning a price to each of the advertising slots based on the highest expected revenue; and
charging the price to the winner of the advertising slot.

8. The method as in claim 1 wherein said step of choosing the winner comprises the step of:
determining from the subset a bipartite graph, wherein the nodes of the bipartite graph include the bidders in the subset and the k advertising slots, and wherein each edge of the bipartite graph connects one bidder i of the subset to one slot j of the advertising slots, and wherein each of the edges is labeled by the expected value of the bid of the bidder i, if the bidder i were placed in the slot j; and
applying a maximum weighted matching algorithm to the bipartite graph to determine the winner of the auction for each of the advertising slots.

9. The method as in claim 1 wherein said step of receiving computer-readable user input comprises the step of:
receiving the computer-readable user input from a user of a service provided through the Internet.

10. The method as in claim 9 wherein said service is an Internet search.

11. The method as in claim 9 wherein said service is an Internet game.

12. The method as in claim 9 wherein said service provides directions.

13. The method as in claim 5 further comprising the steps of:
associating one of the internal states with each bidder in the subset, the internal state being based on a plurality of values of quantities, the values increasing over time;
associating the plurality of values of quantities with a plurality of threshold values, a state transition from one of the internal states to another of the internal states occurring when at least one of the plurality of values crosses the associated threshold;
updating the internal state of a selected bidder when the threshold values associated with the selected bidder are reached; and
adding an amount based on the internal state to a base amount to compute the bid made by the selected bidder.

14. A system for providing an auction for advertising slots comprising:
a program creator/updater for receiving from each bidder, computer-readable instantiations of said computer-readable auction program template and producing from each of said computer-readable instantiations a computer-readable auction program associated with each said bidder, wherein said at least one computer-readable auction program maintains an internal state and wherein said computer-readable auction program includes a bid for at least one of output characteristics subject to conditions from said bidder, wherein said program creator/updater interprets said bids for said output characteristics such that if more than one of the conditions holds, an advertising slot bid is computed as a function of the values for said output characteristics for which the conditions hold;
a user interface for receiving computer-readable user input;
a winner determination processor for determining, from said bidder and for each of the advertising slots, a winner of the auction by:
receiving said computer-readable auction program from said program creator/updater;
receiving said computer-readable user input from said user interface;
choosing a subset of up to k² bidders, k bidders for each of the k advertising slots, where k is the number of the advertising slots; and
choosing, from said subset, said winner for each of the advertising slots based on the advertising slot bid in said computer-readable auction program for each bidder in said subset and based on said computer-readable user input;
wherein said user interface displays an advertisement in each of the advertising slots, said advertisement being associated with said winner of the advertising slot.

15. The system as in claim 14 wherein said computer-readable auction program template includes a plurality of said outcome characteristics and said conditions such that each of said at least one bidders can bid on said plurality of said outcome characteristics simultaneously.

16. The system as in claim 14 wherein is said outcome characteristics comprise advertising slot position, clicks, and purchases.

17. The system as in claim 14 wherein said program creator/updater comprises components for:
automatically updating said internal state based on said winners of the auction for each of the advertising slots; and
updating said computer-readable auction programs based on said internal state and prices paid by said winners for each of the advertising slots.

18. The system as in claim 14 wherein said winner determination processor comprises:
a first set processor for determining a first set of said at least one bidder based on said computer-readable user input; and
a second set processor for determining said subset of said first set, including at most k² bidders, said subset including the k bidders with the highest expected revenue for each of the advertising slots based on said computer-readable auction programs.

19. The system as in claim 18 wherein said winner determination processor further comprises a component for:
computing, for each of the advertising slots, the k bidders for the advertising slot having the highest expected revenue by computing, for each of said output characteristics for said bidder, the expected revenue for each of said output characteristics if bidder were placed in the advertising slot; and
summing the expected revenue over said output characteristics for said bidder.

20. The system as in claim 14 wherein said winner determination processor further comprises:
a maximum weighted matching algorithm processor for
determining from said subset a bipartite graph, wherein nodes of the bipartite graph include said bidders from said subset and the k advertising slots, and wherein each edge of the bipartite graph connects one bidder i of said subset to one slot j of the advertising slots, wherein each of the edges is labeled by the expected revenue of said bid of the bidder i, if the bidder i were placed in the slot j; and
applying a maximum weighted matching algorithm to the bipartite graph to determine said winner of the auction for each of the advertising slots.

21. The system as in claim 18 further comprising:
a pricing processor for
assigning a price to each of the advertising slots based on the highest expected revenue; and
charging said price to said winner of the advertising slot.

22. The system as in claim 14 wherein said user interface comprises a component for:
receiving said computer-readable user input from a user of a service provided through a Internet connection.

23. The system as in claim 22 wherein said service is an Internet search.

24. The system as in claim 22 wherein said service is an Internet game.

25. The system as in claim 22 wherein said service provides directions.

26. The system as in claim 14 wherein said program creator/updates comprises components capable of:
associating said internal state with each said at least one bidder in said subset, said internal state being based on a plurality of values of quantities, said values increasing over time;
associating said plurality of values of quantities with a plurality of threshold values, a state transition from one of said internal states to another of said internal states occurring when at least one of said plurality of values crosses the associated threshold;
updating said internal state of a selected bidder when said threshold values associated with said selected bidder are reached; and
adding an amount based on said internal state to a base amount to compute said bid made by said selected bidder.

27. A computer node in communications with the Internet for carrying out the method according to claim 1.

28. A communications network in communications with the Internet having a computer node for carrying out the method according to any of claim 1.

29. A computer-readable medium having instructions for carrying out the method according to claim 1.
